(19) United States
(12) Patent Application Publication
(10) Pub. No.: US 2017/0311123 A1
(43) Pub. Date: Oct. 26, 2017

(54) Accessory Device for Geo-Localization and Proximity Detection in Industrial Applications and Methods for Operating Same

(71) Applicants: Senni Perumal, Southfield, MI (US); Gerrit Reepmeyer, Novi, MI (US); Anupam Sengupta, Troy, MI (US); Mikhail Zhavoronkov, Northville, MI (US)

(72) Inventors: Senni Perumal, Southfield, MI (US); Gerrit Reepmeyer, Novi, MI (US); Anupam Sengupta, Troy, MI (US); Mikhail Zhavoronkov, Northville, MI (US)

(21) Appl. No.: 15/422,093

(22) Filed: Feb. 1, 2017

Related U.S. Application Data
(63) Continuation-in-part of application No. 15/136,815, filed on Apr. 22, 2016.

(51) Int. Cl. H04W 4/02

(52) U.S. Cl. CPC H04W 4/023

(57) ABSTRACT

Accessory device and method to identify the position of humans or objects and detect their relative proximity in industrial environments.

### INDUSTRIAL APPLICATIONS AND METHODS FOR OPERATING SAME

This patent application is a continuation-in-part of copending patent application having U.S. Ser. No. 15/136,815, filed Apr. 22, 2016.

### BACKGROUND ART

### 1. Field of the Invention

This invention relates to accessory devices that identify the position of humans or objects and detect their relative proximity. More particularly, the invention relates to accessory devices and methods of operating the accessory devices to identify relative proximity of humans and objects that are using the accessory devices.

### 2. Description of the Related Art

Geo-localization and proximity detection are very critical tasks in many applications that involve tracking of humans or objects. For example, in industrial environments, knowing the location of a worker and knowing his/her proximity from a hazard source can decide about life or death of the respective worker.

There are many different wireless technologies available that can help generate 1-dimensional (1-D), 2-D or 3-D geo-localization data to varying degrees of accuracy, for example, Ultra-Wide Band (UWB), differential GPS (dGPS), Wi-Fi, Bluetooth (BLE), RFID, cellular (3G, 4G/LTE), barometers, gyroscopes, or Inertial Measurement Units (IMU). To calculate the location of an object or human, nearly all geo-localization systems require a combination of static infrastructure devices (such as access points or beacons) combined with mobile TAGs that are attached to the people or objects that need to be tracked. Once the beacons and TAGs start communicating with each other, a set of geo-localization algorithms can determine the exact locations of each beacon or TAG. The proximity between TAGs and/or beacons can subsequently be derived based on their location and relative distance from each other.

Other approaches to detect proximity include the use of 1-dimensional (1-D) signal processing directly between two radio-frequency (RF) enabled devices. In these situations, the devices exchange RF signals directly without the need of using a geo-localization infrastructure.

### SUMMARY OF THE INVENTION

This invention addresses the previously described challenges by introducing methods of using accessory devices to identify the position of humans or objects and detect their relative proximity in industrial environments.

In addition to geo-localization and proximity detection, the accessory device will also provide for additional functionalities that can further enhance the safety of the humans or objects wearing the accessory device. These functions may include gas detection, data communication, haptic or audio feedback, as well as visual feedback including indications about signal strengths and battery levels.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view, partially cut away, of an environment in which the invention operates;

FIG. 2 is a perspective view of a top of one embodiment of the invention;

FIG. 3 is perspective view of a bottom of the one embodiment of the invention;

FIG. 4 is a perspective view of FIG. 2 with the top removed;

FIG. 5 is a block diagram of one embodiment of the invention;

FIG. 6 is a logic chart of one embodiment of the inventive method;

FIG. 7 is a logic chart of an alternative embodiment of the inventive method; and

FIG. 8 is a logic chart of a second alternative embodiment of the inventive method.

### DETAILED DESCRIPTION OF THE PREFERRED EMBODIMENT

This invention introduces a proximity detection approach that allows proximity detection using accessory devices, wherein the approach is based on a combination of both the use of an existing geo-localization infrastructure (indirect approach), as well as proximity calculation directly between individual accessory devices (direct approach).

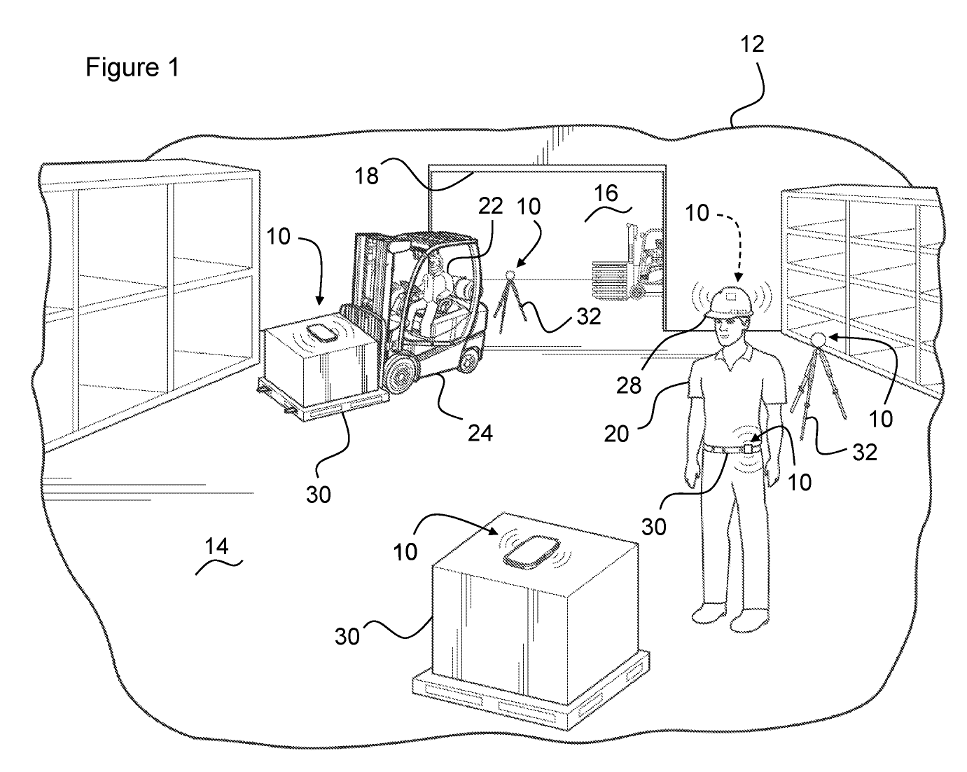

Referring to FIG. 1, one embodiment of the invention is generally shown at 10. The invention is an accessory device 10 that is capable of wireless communication. FIG. 1 also shows a warehouse environment 12 with a first room 14, a second room 16 and a doorway 18 extending therebetween providing access between each room 14, 16. Users 20, 22 of the invention 10 may be in the environment 12, either working individually or operating machinery 24. The accessory devices 10 can be associated with the users 20, 22, machinery 24 or objects 26, such as pallets of goods, all of which have a position/location that varies and proximity to other users 20, 22, machinery 24 and objects 26 would need to be detected. The accessory device 10 can be easily attached to these users 20, 22, machinery 24 and objects 26. The users 20, 22 can wear the accessory devices 10 as part of their personal protective equipment (such as a hard hat 28, belt 30, or other part of clothing/personal protection equipment). The accessory devices 10 may also be secured to structures 32, e.g., tripods, that may be moved when convenient.

The accessory devices 10 are independent RF enabled devices that can do both connecting to an existing geo-localization infrastructure, as indicated in FIG. 1 by the beacons, as well as connecting and communicating with each other. For instance, being part of an existing geo-localization infrastructure will allow the system to identify the absolute location of each accessory device. Not being part of an existing geo-localization infrastructure would require a direct line of communication between the individual accessory devices 10, discussed in greater detail subsequently.

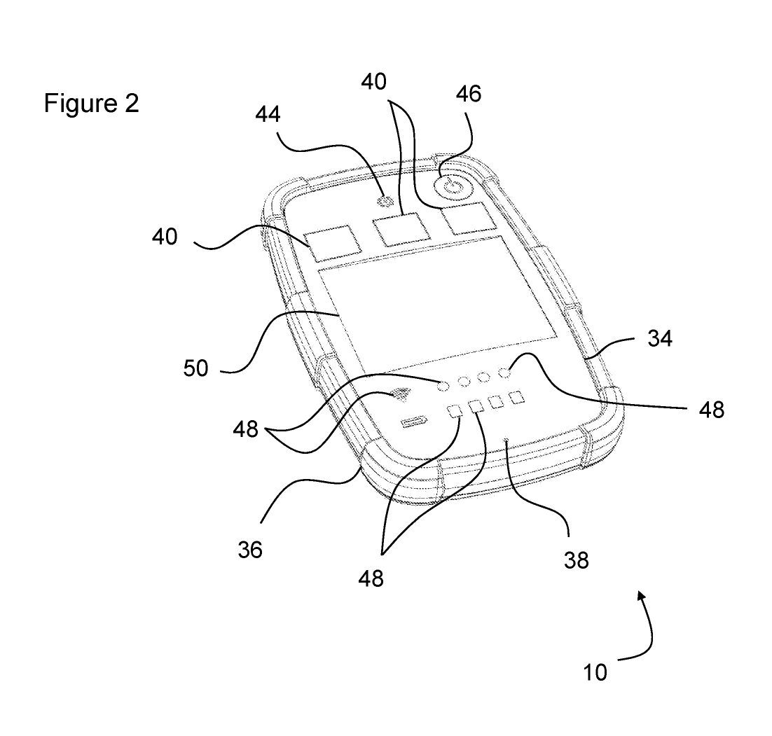

Referring to FIG. 2, a top side of one embodiment of the accessory device 10 is shown. The accessory device 10 a top surface 34 and protective sides bumpers 36. The top surface 34 has apertures through which a microphone 38, operation buttons 40, a speaker 44 and a power button 46 operate or are operated on by a user 20, 22. LEDs 48 are either exposed through holes in the top surface 34 or they emit light that is of a wavelength that may be transmitted through the top surface 34.

A display screen 50 also is visible when viewing the top surface 34. The display screen 50 is capable of indicating messages and status alerts to the user 20, 22. The display screen 50 will also confirm data being sent out away from the accessory device 10.

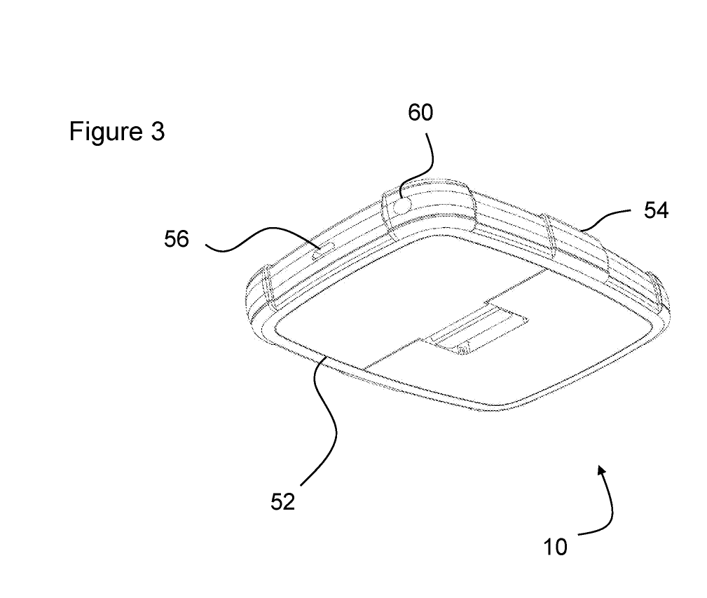

Referring to FIG. 3, a bottom side of the accessory device 10 is shown. A battery compartment (indicated by a battery access panel 52) stores a rechargeable battery (not shown). SOS lights 54 may be disposed on either side of the accessory device 10 within the side bumpers 36. A data/power access port 56 allows for recharging and data dumps. In one embodiment, the data/power access port 56 is a micro-USB connection. In addition, an audio jack 60 provides an opportunity for a user 20, 22 to hear audible signals using ear buds or ear muffs (neither shown). The audio jack 60 may also be used to attach an antenna system to further enhance the ability of the accessory device 10 to receive data.

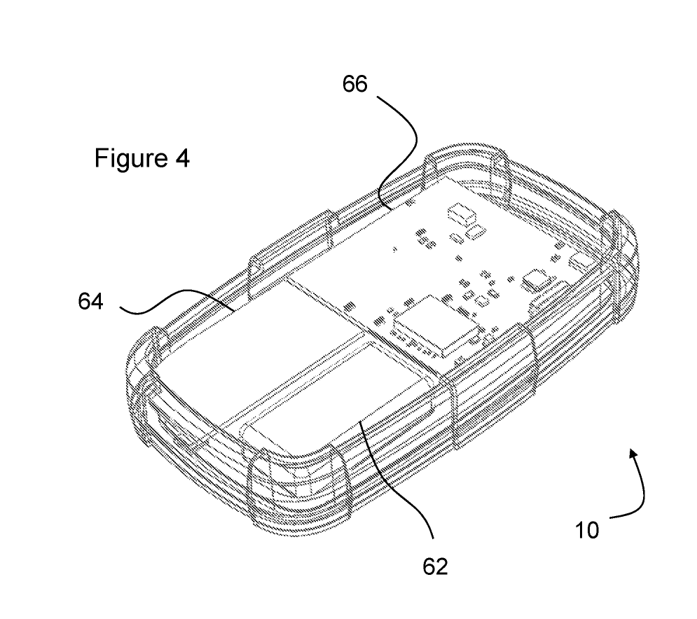

Referring to FIG. 4, the underside of the accessory device 10 is exposed with the removal of the back side thereof. The accessory device 10 includes a battery 62, housed behind the battery access panel 52 (shown in FIG. 3), a power board 64 to regulate power consumption by the accessory device 10 and a tracking board 66. A tracking board 66 is an electronic assembly typically consisting of a printed circuit board (PCB) as well as different RF components that provide for the core technology used for geo-localization and tracking. The tracking board 66 will transmit and receive RF signals that can be used to measure time and distances, which in turn can be used to determine the geo-location of users or objects.

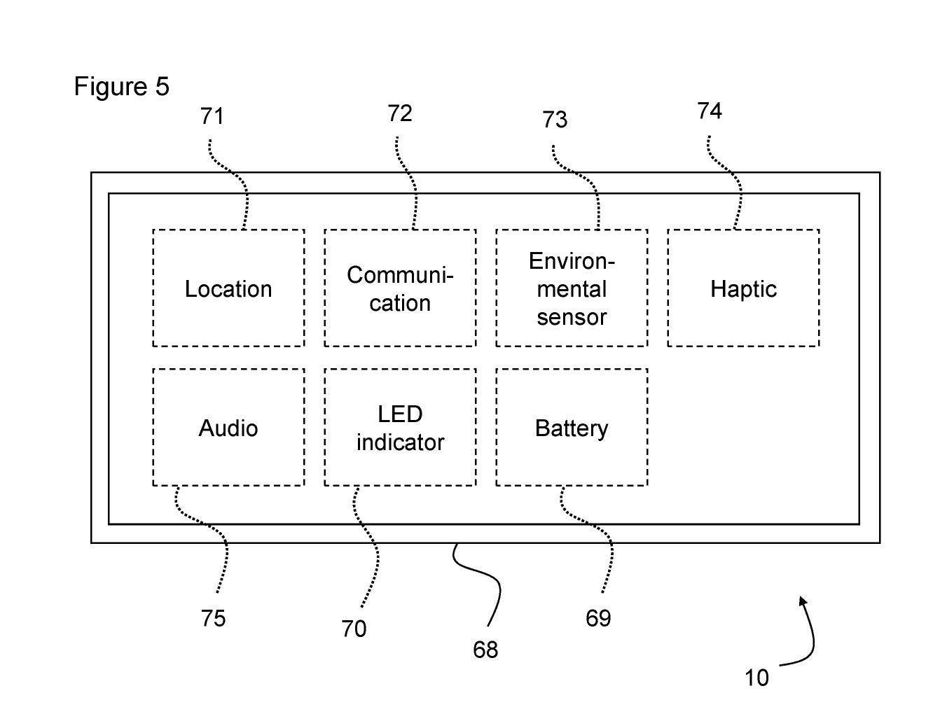

FIG. 5 shows a block diagram of components of the accessory device 10. More specifically, the accessory device 10 includes a casing 68 that encases and protects the electronic components of the accessory device 10. This casing 68 is designed in a way that it will meet the specific requirements of the environments that these accessory devices 10 face. For example, the casing 68 will comply with certain industrial grade or ingress protection standards. The accessory device 10 is powered through a power source 69 that can either be a regular battery, or any other portable power source. A LED light 70 indicates signal strength or battery status to a user that may be deploying the accessory device.

The accessory device 10 may consist of, but is not limited to, any of the following technologies and sub-systems. The accessory device 10 includes electronics capable of utilizing a plurality of wireless localization technologies (WLT) 71. Examples of types of WLT 71 include, but are not limited to, Ultra-Wide Band (UWB), GPS/Differential GPS (dGPS), Wi-Fi, Bluetooth/BLE, RFID, and Cellular (3G, 4G/LTE).

The accessory device 10 may also include a data communications unit 72 allowing it to send and receive transmissions from other accessory devices 10 deployed in the environment and a command or control system used to receive assimilate and transmit information relating to the environment. The accessory device 10 also includes an environmental sensor 73 used to gather information such as temperature, humidity, the presence of noxious gases, and the like.

The accessory device 10 also includes a haptic feedback device 74, which can be used to physically signal or warn a user of the accessory device 10 should the accessory device 10 be worn or if it is in the process of being carried to a location for installation. In one embodiment, the haptic feedback device 74 will vibrate to communicate to the user that it is in an optimal position for deployment. Signaling to the user may also be achieved by using an audio signal unit 75, which may include a speaker to transmit sounds and/or vocal commands to the user. In addition, the audio signal unit 75 may include a microphone allowing the user to speak to someone or a station remote of the accessory device 10.

The accessory device 10 can take different forms or shapes, with one embodiment graphically shown in FIG. 3. In addition to the embodiment shown, the shape of the accessory device 10 can easily allow the accessory device 10 to be non-intrusively attached to the object or human that would need to be tracked.

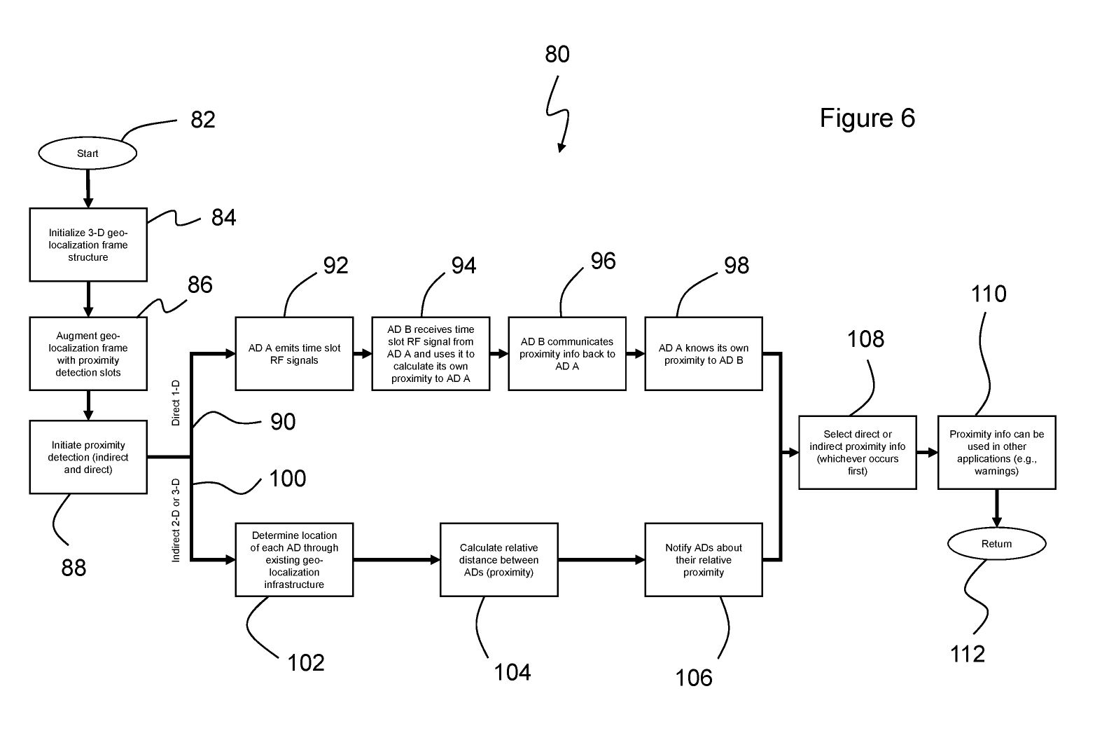

FIG. 6 describes in more detail the methodology used to determine the proximity of accessory devices from each other or from other infrastructure devices. The method, generally shown at 80, begins at 82.

In a first step, the existing 3-D geo-localization frame structure is initialized at 84. A frame structure describes the general setup how the different geo-localization devices communicate with each other. Ultimately, each accessory device 10 will transmit and receive unique RF signals that will be uniquely assigned to the corresponding accessory device(s) 10. In order to make these proximity detection signals unique, they are transmitted in particular slots (proximity detection slots). These slots can either be timeslots or frequency slots. Therefore, in a subsequent step, the geo-localization frame structure will need to be augmented at 86 with the proximity detection slots. After that, the proximity detection can be initiated at 88, both using the direct and indirect method, as set forth in more detail below.

The direct method is branch 90 of the logic chart and it relies on 1-D signal processing. It is initiated by having an accessory device “A” (AD A) emit time slot RF signals at 92. In a next step at 94, the accessory device “B” (AD B) receives time slot RF signal from the AD A and uses it to calculate its own proximity relative to AD A. Afterwards, the AD B communicates its own proximity information back to the AD A at 96. As a result, the AD A knows its own proximity relative to the AD B at 98.

In the indirect method, which is represented by a branch 100, a two-dimensional (2-D) or three-dimensional (3-D) signal is processed. In a first step of this branch at 102, the location of each accessory device 10 (AD) is identified by utilizing the existing geo-localization infrastructure. Based on the locations of each AD 10, the relative distance between each of the ADs can be calculated (proximity) at 104. In a next step, all ADs can be notified about their relative proximity to each other at 106.

Depending on which of the two branch 90, 100 that finish first, at 108, the branch that produces the result in the shortest amount of time is selected. The proximity data is then distributed for functional uses at 110. The method 80 then returns at 112 to calculate proximities again.

Given that both the direct 90 and indirect 100 methods run in parallel, both processes will provide proximity information about each of the accessory devices 10. This is beneficial in many ways, because both methods fundamentally work in different ways and therefore deliver results independently of each other. While the direct method does not rely on a functioning infrastructure and therefore will typically deliver proximity results faster, it requires a direct line of sight (or at least permeable structures) for the accessory devices to communicate directly with each other. On the other hand, the indirect method is independent of a direct line of sight connection because it functions through the network of existing access points and beacons. With both methods delivering results in parallel, one method will effectively function as a backup for the other and vice versa, in case the environmental conditions won't allow either one of the methods to function properly. Particularly in industrial environments where existing plant infrastructures do not always allow for a complete and error-free operation of a geo-localization infrastructure, redundant systems to determine location and proximity are highly critical, particularly when proximity detection shall be used to improve worker safety and protect people's lives.

In case both the direct and indirect proximity detection method accurately deliver proximity information, the accessory device will select the information that is provided first. The difference in accuracy between both methods can be considered negligible so that there will not be any negative impact on information accuracy.

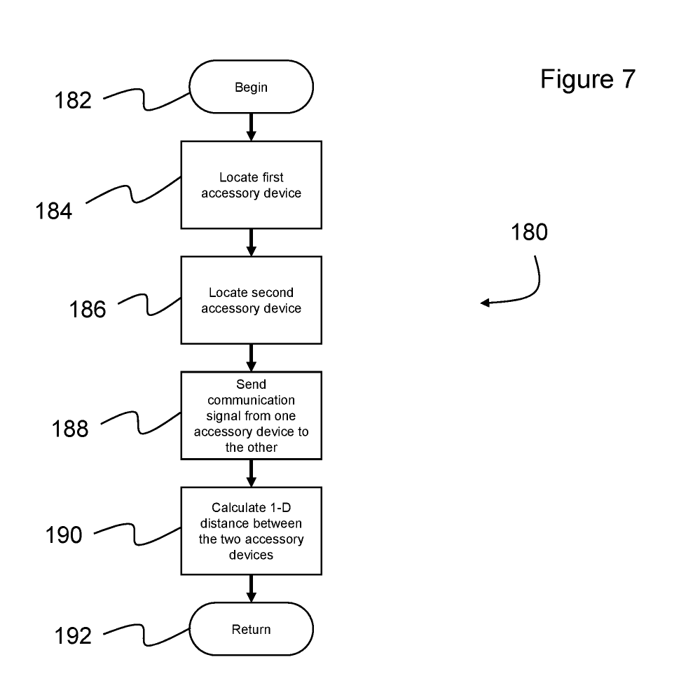

Referring to FIG. 7, an alternative embodiment is generally shown at 180. In this method, the method 180 measures the distance between first and second accessory devices 10. The method 180 begins at 182. A first accessory device 10 is located at 184. Location of the accessory device 10 is done without communication with any other device local to the first accessory device 10. In one embodiment, the ability for the first accessory device 10 to identify its location is done through a GPS chipset that may be designed into the accessory device 10.

The method 180 continues with a second accessory device 10 locating itself at 186. The second accessory device 10 will operate similar to the first accessory device 10. As such, it may do so using a similar GPS chipset. Once the first and second accessory devices 10 have identified their respective locations, a communication signal is sent from one to the other at 188. When the other of the two accessory devices 10 receives the communication signal, it can then calculate a 1-D distance between the two accessory devices 10 at 190. The method 180 concludes at 192.

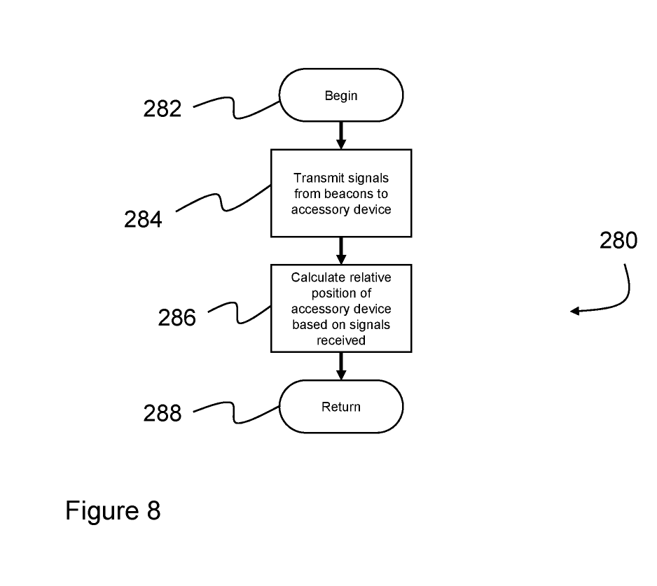

Referring to FIG. 8, a second alternative embodiment is generally shown at 280. In this method, which begins at 282, the accessory device 10 does not use a GPS chipset or any other system to independently identify its location. In this method, the accessory device 10 identifies its location relative to other similar devices in the area. Beacons or other accessory devices 10 in the area transmit signals to the accessory device 10 at 284. The accessory device 10 then receives all the information from the various signals it has detected and received and identifies its own location at 286. The location identified is relative to all the other devices that transmitted information. If those devices have actual location information, either by being able to detect its own location or because it was programmed into the device, the accessory device 10 will be able to identify its actual, real location and not merely its location relative to the other devices. Regardless of whether the accessory device 10 has identified its real or relative location, is said to be self-aware in that it can continue to calculate its location from the signals it is receiving. The method 280 concludes at 288.

The resulting proximity information can now be used in a variety of applications, such as a safety application that will issue warning signals in case proximity between certain humans and/or certain objects becomes critical.

Besides of location and proximity data, the accessory devices can also transfer and share information with each other about additional parameters, for example, data from environmental sensors.

By using a plurality of notification techniques, such as haptic feedback, audio feedback or visual feedback through LED indicators, a detected proximity or hazard exposure can be immediately communicated by the accessory device either to a worker himself/herself or to any other reference point, such as a central control center.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. An accessory device that detects proximity to another accessory device or geo-localization device using a combination of an indirect and direct proximity detection method.

2. An accessory device as set forth in claim 1 wherein the device can utilize any geo-localization technology.

3. An accessory device as set forth in claim 1 wherein the device contains an environmental sensor.

4. An accessory device as set forth in claim 1 wherein the device contains a communications unit to ensure wireless data transfer to and from the accessory device.

5. An accessory device as set forth in claim 1 wherein the device has haptic prompts.

6. An accessory device as set forth in claim 1 wherein the device has audio prompts.

7. An accessory device as set forth in claim 1 wherein the device indicates signal strength and battery lifetime.

8. A method for detecting the relative proximity of an accessory device to a plurality of other accessory devices using a combination of an indirect and direct proximity detection approach, the method comprising the steps of:
initializing an existing geo-localization frame structure;
determining one proximity data point using an existing geo-localization infrastructure;
determining another proximity data point using time slot RF signals;
selecting the direct or indirect proximity information based on timing of when each information is made available.

9. A method for measuring a distance between a first accessory device and a second accessory device, the method including the steps of:
initializing a communication signal by the first accessory device;
transmitting the communication signal out from the first accessory device;
receiving the communication signal by the second accessory device;
calculating a one-dimensional distance between the first and second accessory devices;
transmitting a first location signal to a mapping system by the first accessory device;
receiving a first position signal from the mapping system;
transmitting a second location signal to the mapping system by the second accessory device;
receiving second position signal from the mapping system;
calculating a relative position of the first and second accessory devices from the first and second position signals; and
using the one-dimensional distance or the relative position based on which of the one-dimensional distance and the relative position is calculated faster.

10. A method for measuring a distance between a first accessory device and a second accessory device, the method including the steps of:
initializing a communication signal by the first accessory device;
transmitting the communication signal out from the first accessory device;
receiving the communication signal by the second accessory device;
calculating a one-dimensional distance between the first and second accessory devices;
transmitting a first location signal to a mapping system by the first accessory device;
receiving a first position signal from the mapping system;
transmitting a second location signal to the mapping system by the second accessory device;
receiving second position signal from the mapping system;
calculating a relative position of the first and second accessory devices from the first and second position signals; and
comparing the one-dimensional distance with the relative position to determine the most accurate distance between the first and second accessory devices.

11. A method for measuring a distance between a first accessory device and a second accessory device, the method including the steps of:
initializing a communication signal by the first accessory device;
transmitting the communication signal out from the first accessory device;
receiving the communication signal by the second accessory device;
transmitting a first location signal to a mapping system by the first accessory device;
receiving a first position signal from the mapping system;
transmitting a second location signal to the mapping system by the second accessory device;
receiving second position signal from the mapping system;
calculating a relative position of the first and second accessory devices from the first and second position signals; and
communicating the relative positions of the first and second accessory devices to each of the first and second accessory devices such that each of the first and second accessory devices can determine the location of itself relative to the other.

12. A method for measuring a distance between a first accessory device and a second accessory device, the method including the steps of:
initializing a communication signal by the first accessory device;
transmitting the communication signal out from the first accessory device;
receiving the communication signal by the second accessory device; and
calculating a one-dimensional distance between the first and second accessory devices.

13. A method as set forth in claim 12 including the step of locating the first accessory device prior to the step of initializing the communication signal by the first accessory device.

14. A method as set forth in claim 13 including the step of locating the second accessory device based on the one-dimensional distance and the location of the first accessory device.

15. A method for identifying a location of an accessory device using a plurality of other devices, the method including the steps of:
receiving communication signals from the plurality of other devices; and
calculating a location based on relative distances between the accessory device and each of the plurality of other devices by incorporating the information delivered by the communication signals from each of the plurality of other devices.
